(19) United States
(12) Patent Application Publication
(10) Pub. No.: US 2026/0070344 A1
(43) Pub. Date: Mar. 12, 2026

(54) LIQUID EJECTION HEAD, LIQUID EJECTION APPARATUS, AND DRIVING METHOD FOR LIQUID EJECTION HEAD

(71) Applicant: CANON KABUSHIKI KAISHA, Tokyo (JP)

(72) Inventors: AYAKO IWASAKI, Kanagawa (JP); YOSHIYUKI NAKAGAWA, Kanagawa (JP); TAKASHI KATO, Kanagawa (JP)

(21) Appl. No.: 19/322,821

(22) Filed: Sep. 9, 2025

(30) Foreign Application Priority Data
Sep. 10, 2024 (JP) 2024-156981

(51) Int. Cl. B41J 2/20; B41J 2/045; B41J 2/14

(52) U.S. Cl. CPC B41J 2/20; B41J 2/04573; B41J 2/0458; B41J 2/04596; B41J 2/14032; B41J 2/14088; B41J 2/14145; B41J 2/1433

(57) ABSTRACT

A liquid ejection head includes a pressure chamber for ejecting liquid, a first energy generating element for generating energy to eject the liquid, and circulating flow passages, each of which is provided with a second energy generating element and has a supply port through which liquid to the pressure chamber flows in and a discharge port through which liquid from the pressure chamber is discharged, and the pressure chamber being disposed between the supply port and the discharge port. The supply port is located on one side of the pressure chamber the discharge port is located on the other side of the pressure chamber, and the supply port, pressure chamber, and discharge port are arranged in this order. The second energy generating element is disposed on a side closer to the supply port than the pressure chamber, and is driven while the first energy generating element is stopped.

### BACKGROUND

### Field of the Technology

The present disclosure relates to a liquid ejection head.

### Description of the Related Art

In liquid ejection heads such as inkjet recording heads, one factor that degrades image quality is the concentration of ink (liquid). At ejection nozzles where ejection has not been performed for a while, evaporation of ink from the ejection nozzles progresses, causing the viscosity of the ink to increase, which affects ejection. As a result, variations in ejection amount and direction occur, causing streaks and density unevenness in the image, thereby lowering image quality.

To prevent the concentration of ink as described above, in recent years, mechanisms for circulating ink within the liquid ejection head have been proposed. By circulating the ink, it is possible to flush out the concentrated ink near the ejection nozzles and supply fresh ink.

As one means of circulation, there is a method in which an electrothermal transducer is disposed within the circulating flow passage. When the ink is heated by the electrothermal transducer, bubbles grow due to film boiling of the ink, and during the subsequent contraction process, a flow is generated, causing the ink to circulate within the flow passage. In order to resolve the thickening of ink at the ejection nozzle portion and supply fresh ink, it is desirable to circulate the ink continuously. However, if the electrothermal transducer is driven continuously, there is concern that local heating may hinder bubble generation, resulting in a decrease in flow rate.

Therefore, WO 2016-068988 discloses a configuration in which, in a U-shaped circulating flow passage, one energy generating element for ejecting liquid and one electrothermal transducer for delivering liquid within the circulating flow passage including the pressure chamber are arranged consecutively within the circulating flow passage, and the electrothermal transducer is driven intermittently to generate an intermittent circulating flow.

In WO 2016-068988, it is characterized in that the electrothermal transducer is driven intermittently in a U-shaped circulating flow passage configuration. In the U-shaped circulating flow passage, since the liquid inflow portion and outflow portion of the circulating flow passage are arranged close to each other, when driven intermittently, the concentrated ink from the outflow portion side is recirculated to the inflow portion, thereby promoting concentration. Accordingly, there is a risk that the ejection performance (also referred to as firing property) of the initial ejection in continuous ejection from the ejection nozzle may deteriorate.

### SUMMARY

Accordingly, the present disclosure is directed to provide a liquid ejection head capable of further improving circulation efficiency by means of a flow passage configuration and driving method that suppresses recirculation concentration.

To solve the above problem, a liquid ejection head according to the present disclosure includes:
a plurality of liquid ejection portions each having an ejection nozzle for ejecting liquid, a pressure chamber, and a first energy generating element for generating energy to eject the liquid from the ejection nozzle;
a plurality of circulating flow passages provided corresponding to the plurality of liquid ejection portions, each circulating flow passage having a supply port through which liquid supplied to the pressure chamber flows in and a discharge port through which liquid collected from the pressure chamber is discharged, the pressure chamber being disposed between the supply port and the discharge port; and
a second energy generating element provided in the circulating flow passage;
wherein the plurality of liquid ejection portions are arranged in a first direction,
wherein each of the plurality of circulating flow passages extends in a second direction intersecting the first direction, such that the supply port is located on one side of the pressure chamber in the second direction, the discharge port is located on the other side of the pressure chamber in the second direction, and the supply port, pressure chamber, and discharge port are arranged in this order in the second direction,
wherein the second energy generating element is disposed in the circulating flow passage on a side closer to the supply port than the pressure chamber,
wherein the second energy generating element is driven multiple times at a first time interval between a first timing at which the first energy generating element is driven and a second timing at which the first energy generating element is driven next after the first timing, and
wherein a third time interval between the first timing and a third timing at which the second energy generating element is driven next after the first timing includes a circulation generating operation greater than the first time interval.

Additionally, to solve the above problem, a liquid ejection apparatus according to the present disclosure includes:
the liquid ejection head according to the present disclosure; and
a control portion for controlling driving of the second energy generating element,
wherein the control portion drives the second energy generating element while driving of the first energy generating element is stopped.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view showing a configuration of a first embodiment of a liquid ejection apparatus in which a main ink tank is provided in the apparatus main body and a sub ink tank is provided in the liquid ejection head.

FIG. 1B is a perspective view showing a configuration example in which no main ink tank is provided and an ink tank is provided directly above the liquid ejection head.

FIG. 2 is a block diagram showing the control system of the first embodiment of the liquid ejection apparatus.

FIG. 3 is a perspective view of the inkjet recording head.

FIG. 4 is a view showing the recording element substrate in the comparative example as seen from the side facing the ejection nozzle.

FIG. 5 is a view showing the recording element substrate in the first embodiment as seen from the side facing the ejection nozzle.

FIG. 6A is a cross-sectional view of the recording element substrate in the first embodiment, in which the supply-side through flow passage and the discharge-side through flow passage are formed in a second substrate laminated on the second surface of the first substrate, and each communicates with a common flow passage extending in the ejection nozzle row direction.

FIG. 6B is a cross-sectional view showing a configuration in which the thickness of the first substrate is increased and the passage between the supply-side through flow passage and the discharge-side through flow passage via the common flow passage is made longer.

FIG. 6C is a cross-sectional view showing a configuration in which the supply-side common flow passage communicates with the circulating flow passage via the supply-side through flow passage, and the discharge-side common flow passage communicates with the circulating flow passage via the discharge-side through flow passage.

FIG. 7A is a schematic diagram of the drive signal for the electrothermal transducer when, in the first embodiment, a drive pulse is supplied to the element at each optimal drive pulse pause period within the ejection pulse pause period, so that the electrothermal transducer is driven repeatedly and evenly.

FIG. 7B is a schematic diagram of the drive signal for the electrothermal transducer when, in the first embodiment, within the ejection pulse pause period, the time interval between the first timing and the timing immediately following the first timing at which the next element drive pulse is supplied is different from the predetermined time interval, and the subsequent element drive pulses are supplied at even intervals during the drive pulse pause period, thereby driving the electrothermal transducer.

FIG. 7C is a schematic diagram of the drive signal for the electrothermal transducer when, in the first embodiment, within the ejection pulse pause period, the time interval until the element drive pulse is supplied immediately before the second timing at which the energy generating element is driven after the first timing is different from the predetermined time interval, thereby driving the electrothermal transducer.

FIG. 7D is a schematic diagram of the drive signal for the electrothermal transducer when, in the first embodiment, within the ejection pulse pause period, the pause period from the first timing when the energy generating element is driven to the timing at which the electrothermal transducer is driven is shorter than the predetermined time interval, and the pause period between the timing at which the element drive pulse is supplied immediately before the second timing immediately following the first timing at which the energy generating element is driven and the second timing is different from the predetermined time interval, thereby driving the electrothermal transducer.

FIG. 8A is a schematic diagram of the drive signal for the electrothermal transducer when, in the second embodiment, within the ejection pulse pause period, the element drive pulse is supplied at each optimal drive pulse pause period to drive the electrothermal transducer evenly, and the element drive pulse is also supplied immediately before the second timing at which the energy generating element is driven after the first timing.

FIG. 8B is a schematic diagram of the drive signal for the electrothermal transducer when, in the second embodiment, within the ejection pulse pause period, for the first several times from the first timing, the element drive pulse is supplied at even drive pulse pause periods to drive the electrothermal transducer, and the time interval between the timing at which the element drive pulse is supplied immediately before the second timing immediately following the first timing and the timing at which the previous element drive pulse is supplied is shorter than the predetermined time interval, thereby driving the electrothermal transducer.

### DESCRIPTION OF THE EMBODIMENTS

Embodiments of the present disclosure will now be described in detail, on the basis of examples, with reference to the drawings. However, the dimensions, materials, shapes, relative arrangements, and the like of the components described in the embodiments may be appropriately modified in accordance with the configurations and various conditions of apparatuses to which the present disclosure is applied. In addition, not all combinations of features described in the present embodiment are essential to the solution of the present invention. The constituent elements described in the embodiments are merely examples, and the scope of the present disclosure is not intended to be limited only thereto.

### First Embodiment

A description will be given of a liquid ejection apparatus 50 according to the first embodiment of the present disclosure. The liquid ejection apparatus 50 is an inkjet recording apparatus that uses an inkjet recording method, and includes a liquid ejection head 1 capable of ejecting ink as a liquid.

### Liquid Ejection Apparatus

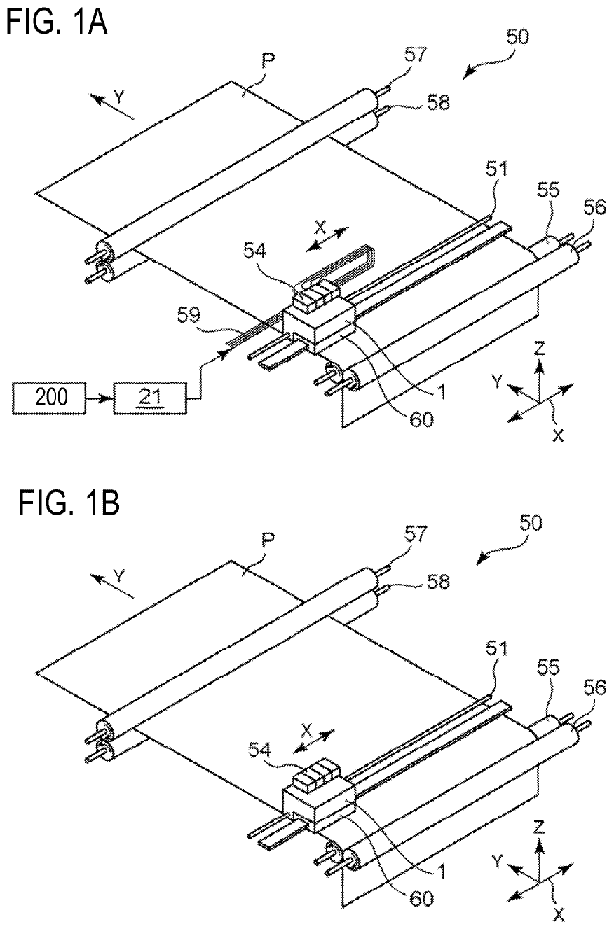

FIGS. 1A and 1B are perspective views illustrating the configurations of liquid ejection apparatuses 50 according to Example 1. The liquid ejection apparatuses 50 illustrated in FIGS. 1A and 1B are liquid ejection apparatuses of a form in which image recording is performed by ejecting a liquid onto a recording medium P using a liquid ejection head 1 scanning in a direction intersecting with a conveyance direction of the recording medium P (a serial-type liquid ejection apparatus). The present disclosure is not limited to the serial-type liquid ejection apparatus and can be applied also to a liquid ejection apparatus of a page wide-type in which image recording is performed by ejecting liquid onto a recording medium conveyed in a conveyance direction using a line head (a page wide-type head) that is long in a page width direction of the recording medium. The liquid ejection head 1 according to the present embodiment can eject ink of four types including black (K), cyan (C), magenta (M), and yellow (Y) and record a full-color image using such ink. The ink that can be ejected from the liquid ejection head 1 is not limited to the ink of four types described above. The present disclosure can be applied also to a liquid ejection head that can eject ink of other types, and the types and the number of inks ejected from the liquid ejection head are not particularly limited.

In the following description, the scanning direction (movement direction) of the liquid ejection head 1 is the X direction, the conveyance direction of the recording medium P in the recording portion is the Y direction, and the vertical direction is the Z direction. The X direction, the Y direction, and the Z direction intersect with one another (in the present example, the directions are perpendicular to one another). In some cases, the scanning direction (movement direction) of the liquid ejection head 1 may be referred to as a main scanning direction, and the conveyance direction of the recording medium P may be referred to as a sub-scanning direction.

In the serial-type liquid ejection apparatus 50, the liquid ejection head 1 is mounted on a carriage 60. The carriage 60 reciprocates along a guide shaft 51 in the main scanning direction (X direction). The recording medium P is conveyed in the sub-scanning direction (Y direction) that intersects with (in the present example, perpendicular to) the main scanning direction by conveyance rollers 55, 56, 57, and 58 that constitute a conveyance portion (conveyance unit).

FIG. 1A is a perspective view illustrating an exemplary configuration in which a main ink tank 200 as a liquid storage portion is provided to a main body of the liquid ejection apparatus 50 (external to the liquid ejection head 1), and a sub-ink tank 54 is provided to the liquid ejection head 1. The liquid (ink) stored in the ink tank 200 is supplied, with a driving force of an external pump 210, to the sub-ink tank 54 inside the liquid ejection head 1, through an ink supply tube (liquid passage) 59, for example. In other words, in the example illustrated in FIG. 1A, the liquid storage portion where the ink is stored is provided to each of the main body and the liquid ejection head 1 of the liquid ejection apparatus 50.

FIG. 1B is a perspective view illustrating an exemplary configuration not provided with the main ink tank 200 but provided with an ink tank 54 immediately above the liquid ejection head 1. The liquid ejection head 1 may be integrated with the ink tank 54, and configured to be removable from the carriage 60. Alternatively, the liquid ejection head 1 may be integrated with the carriage 60, while only the ink tank 54 is configured to be removable. The configuration illustrated in FIG. 1A will be used as a representative example in the following description.

The liquid ejection head 1 includes an individual ejection unit, which will be described later. The individual ejection unit, a specific configuration of which will be described later, is a recording element unit including an ejection nozzle through which a liquid is ejected, a pressure chamber communicating with the ejection nozzle, and an individual circulating flow passage communicating with the pressure chamber. The individual ejection unit includes a first energy generating element (ejection energy generating element) that is provided at a position corresponding to the pressure chamber, and generates the energy for causing the ejection nozzle to eject the liquid, and a second energy generating element (electrothermal transducer) that is provided at a position corresponding to the individual circulating flow passage. The liquid ejection head 1 includes a plurality of individual ejection units, and has a supply flow passage for supplying the liquid to the individual circulating flow passage in each individual ejection unit.

When the liquid ejection head 1 is used, ejection of liquid may become unstable due to evaporation of volatile components such as water at the ejection nozzle and the resulting solid content concentration near the ejection nozzle. Thus, various measures have been taken to prevent the ejection from becoming unstable. For example, the liquid ejection apparatus 50 may be provided with a cap member (not illustrated) at a position away from the conveyance passage of the recording medium P in the X direction. The cap member is capable of covering the ejection nozzle surface on which the ejection nozzles of the liquid ejection head 1 are formed. The cap member is used to prevent the ejection nozzles from drying and to protect the ejection nozzles by covering the ejection nozzle surface of the liquid ejection head 1 when the recording operation is not being performed.

It is also possible to provide an ink suction mechanism (not illustrated) to the liquid ejection apparatus 50. With such an ink suction mechanism provided, a cap member is used in the operation of suctioning ink from the ejection nozzle, for example. By performing this ink suctioning operation, it is possible to refresh the ink near the ejection nozzle and to maintain the image quality of images achieved.

Furthermore, it is also possible to discard the thickened ink by executing what is called preliminary ejection (pre-ejection) while the recording operation is not being performed. Such preliminary ejection may be performed during the recording operation, too, by ejecting an unnoticeable amount of ink to the recording medium, at a position unnoticeable in terms of the image quality (paper sheet preliminary ejection/in-page preliminary ejection). Although these methods contribute greatly to the improvement of image quality, there is a demand for reducing the amount of waste ink as much as possible, because some of the ink is discarded in refreshing the ejection nozzle.

To address these issues, by providing an electrothermal transducer as the second energy generating element in the circulating flow passage and circulating ink within the flow passage, it is possible to suppress drying of the ejection nozzles and concentration of ink near the ejection nozzles while reducing the amount of waste ink. More specifically, the number of times preliminary ejection or suction recovery is performed can be reduced as much as possible. Further, by reducing the number of preliminary ejection operations and the like, the throughput and yield thereof can be improved.

The second energy generating element (electrothermal transducer) does not necessarily have to be provided in all individual ejection units of the liquid ejection head. In a case where the second energy generating element is provided in some of the individual ejection units, the above-described effect can be achieved more effectively than in a case where no second energy generating elements are provided.

It is also possible for the liquid ejection head 1 to have a configuration in which all the portions respectively corresponding to the four inks are provided with the second energy generating elements, or a configuration in which only a portion corresponding to one of the inks is provided with the second energy generating elements. That is, the liquid ejection head may be designed to circulate not all the four types of ink, but only at least one type of ink.

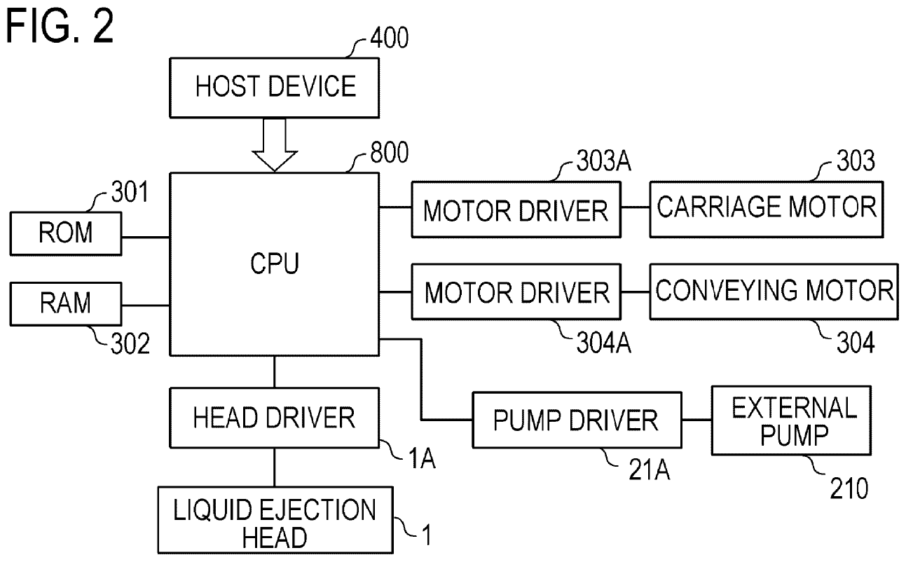

FIG. 2 is a block diagram illustrating a control system of the liquid ejection apparatus 50. A CPU 800 is a control portion for controlling the operation of the portions of the liquid ejection apparatus 50, on the basis of a program such as a processing procedure stored in a ROM 301. A RAM 302 is used as a working area or the like, when the CPU 800 executes processing. The CPU 800 receives image data from a host device 400 external to the liquid ejection apparatus 50, and controls the driving of the elements provided to the liquid ejection head 1 by controlling a head driver 1A based on the image data.

The CPU 800 also controls drivers of various types of actuators provided in the liquid ejection apparatus 50. For example, the CPU 800 controls a motor driver 303A of a carriage motor 303 for moving the carriage 60, a motor driver 304A of a conveying motor 304 for conveying the recording medium P, and a pump driver 21A of the external pump 210. Although FIG. 2 illustrates a configuration in which the image data is received from the host device 400, it is also possible to execute processing on the liquid ejection apparatus 50 without using any data from the host device 400.

### Description of Head Configuration

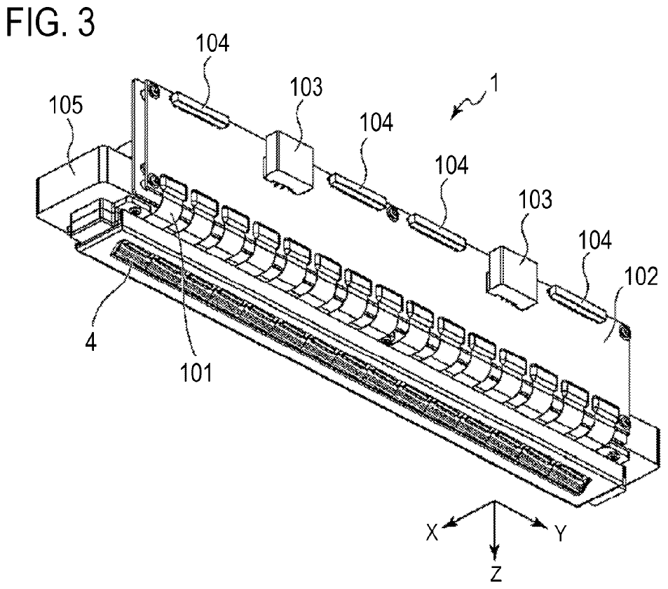

FIG. 3 is a perspective view of an inkjet recording head 1 (hereinafter simply referred to as a recording head) usable as the liquid ejection head of the present disclosure. The recording head 1 is configured such that a plurality of recording element substrates 4, each having a plurality of recording elements arranged in the Y direction, are further arranged in the Y direction. Here, the recording head 1 shown is a full-line type recording head in which the recording element substrates 4 are arranged in the Y direction over a distance corresponding to the width of A4 size paper.

Each recording element substrate 4 is connected to the same electrical wiring substrate 102 via a flexible wiring substrate 101. The electrical wiring substrate 102 is provided with a power supply terminal 103 for receiving power and a signal input terminal 104 for receiving ejection signals sent from the CPU 800. Meanwhile, the ink supply unit 105 is formed with a circulating flow passage for supplying ink from an ink tank (not shown) to each recording element substrate 4 and for collecting ink not consumed in recording.

With the above configuration, each recording element arranged on the recording element substrate 4 ejects ink supplied from the ink supply unit 105 in the Z direction of the figure, using power supplied from the power supply terminal 103 based on ejection signals input from the signal input terminal 104.

### Description of Recording Elements

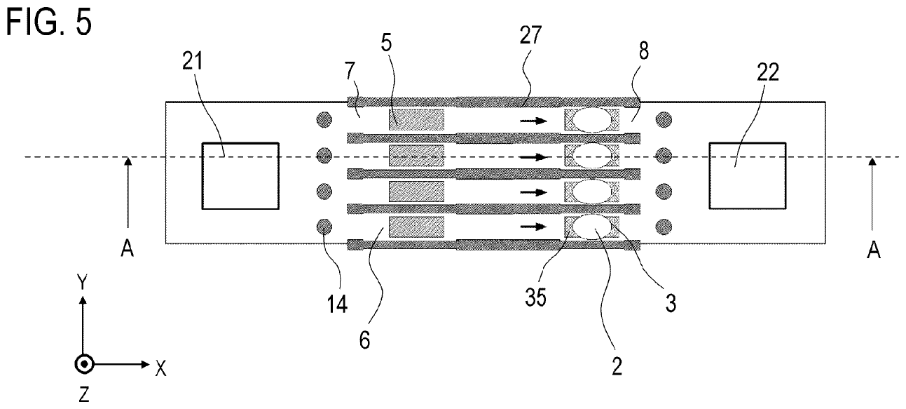

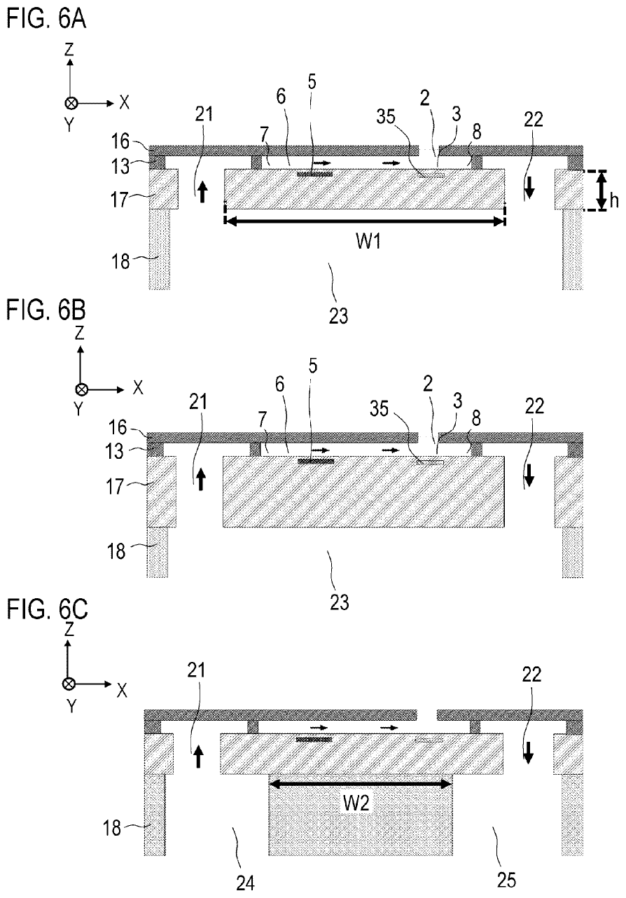

FIG. 5 is an enlarged view of a part of the recording element substrate 4 of the recording head 1 shown in FIG. 3, showing the flow passage configuration near the ejection nozzle in this embodiment as viewed from the side of the recording element substrate 4 facing the ejection nozzle (+Z direction). FIGS. 6A to 6C show sectional views taken along direction AA in FIG. 5.

In FIG. 6A, an energy generating element 35 (first energy generating element), which is an electrothermal transducer that generates energy to eject ink from the pressure chamber, is disposed on the surface of the first substrate 17. At the position of the orifice plate 16 corresponding to the energy generating element 35, an ejection nozzle 2 is formed. On the surface of the first substrate 17, in the X direction, which is the second direction perpendicular to the Y direction, which is the direction of the ejection nozzle row, an electrothermal transducer 5 (second energy generating element) is disposed adjacent to the energy generating element 35. In FIG. 5, the pressure chambers 3 are provided with partition walls 27 between the ejection nozzles 2 and energy generating elements 35 arranged in the Y direction. The partition wall 27 forming the pressure chamber 3 extends in the X direction perpendicular to the Y direction of the ejection nozzle row, forming a liquid ejection portion including the pressure chamber 3, ejection nozzle 2, and energy generating element 35, and a circulating flow passage 6 including the electrothermal transducer 5. That is, on the first surface side of the first substrate 17 where the energy generating element 35 is disposed, a flow passage forming member (first flow passage forming member) including the partition wall 27 is provided between adjacent pressure chambers 3 in the Y direction and the circulating flow passage 6. The orifice plate 16 is laminated on the opposite side of the first substrate 17 from the flow passage forming member. The pressure chamber 3 and the circulating flow passage 6 are defined by the first surface of the first substrate 17, the partition wall 27, and the orifice plate 16. The circulating flow passage 6 communicates with a supply flow passage 7 (supply port) provided on one side of the pressure chamber 3 and a discharge flow passage 8 (discharge port) provided on the other side. Specifically, in this embodiment, the flow passage configuration in which the supply flow passage 7 and discharge flow passage 8 are arranged on respective sides of the pressure chamber 3 in the X direction, and the supply flow passage 7, pressure chamber 3, and discharge flow passage 8 are arranged in the order shown in FIG. 5, is referred to as a straight-type flow passage configuration. As shown in FIG. 5, on the first surface side, which is one surface side, of the first substrate 17 of the recording head 1, a plurality of liquid ejection portions including the pressure chamber 3, ejection nozzle 2, and energy generating element 35 are formed and aligned along the Y direction. Additionally, a plurality of circulating flow passages 6 communicating with the supply flow passage 7 and discharge flow passage 8 are also formed along the Y direction. A supply-side through flow passage 21 communicating with the supply flow passage 7 from an outer side of the supply flow passage 7 is formed so as to penetrate the first substrate 17 in the Z direction, which is the third direction intersecting both the X and Y directions, between the first surface and the second surface, which is a back surface. Similarly, a discharge-side through flow passage 22 communicating with the discharge flow passage 8 from an outer side of the discharge flow passage 8 is formed so as to penetrate the first substrate 17 in the Z direction.

The supply-side through flow passage 21 and the discharge-side through flow passage 22 are, as shown in FIG. 6A, formed in a second substrate 18 (second flow passage forming member) laminated on the second surface of the first substrate 17, and each communicates with a common flow passage 23 extending in the ejection nozzle row direction.

In this case, the flow passage height h in the Z direction (corresponding to the thickness of the first substrate 17) of the supply-side through flow passage 21 and the discharge-side through flow passage 22 formed in the first substrate 17 is set to 50 to 200 μm, and the interval W1 in the X direction between the supply-side through flow passage 21 and the discharge-side through flow passage 22 is set to 50 to 300 μm. To ensure refilling to the ejection nozzle 2, it is necessary to minimize pressure loss, so a first substrate 17 may be thin. However, to suppress the effect of recirculation concentration, as shown in FIG. 6B, it is also acceptable to make the thickness of the first substrate 17 thicker within the range of 50 to 200 μm and configure the passage between the supply-side through flow passage 21 and the discharge-side through flow passage 22 via the common flow passage 23 to be longer.

Further, as shown in FIG. 6C, it is also possible to form, in the second substrate 18, a supply-side common flow passage 24 extending in the ejection nozzle row direction and communicating with the supply-side through flow passage 21, and a discharge-side common flow passage 25 extending in the ejection nozzle row direction and communicating with the discharge-side through flow passage 22, and to have each communicate with a common flow passage outside the recording head (not shown). That is, the supply-side common flow passage 24 communicates with the circulating flow passage 6 via the supply-side through flow passage 21, and the discharge-side common flow passage 25 communicates with the circulating flow passage 6 via the discharge-side through flow passage 22. By separating the supply-side common flow passage 24 and the discharge-side common flow passage 25, an even greater effect in suppressing recirculation concentration can be expected. Additionally, regarding the interval W2 between the supply-side common flow passage 24 and the discharge-side common flow passage 25, when the first substrate 17 and the second substrate 18 are bonded together, it is necessary to secure an adhesive margin, so W2 is set to be at least 50 μm.

As described above, it is acceptable to form each flow passage by dividing them between the first and second substrates, or to form the supply-side through flow passage 21 and the discharge-side through flow passage 22 in a single substrate.

### Description of Drive Signal

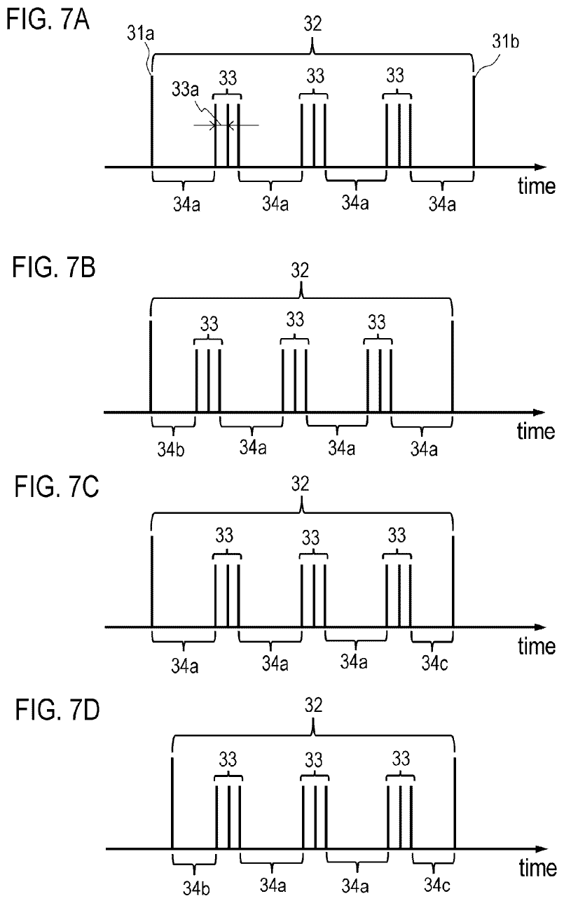

To resolve the thickening of ink in the flow passage and supply fresh ink to the ejection nozzle, in the present disclosure, the electrothermal transducer 5 is driven during the period when the driving of the energy generating element 35 is stopped between the timings for ejecting ink from the ejection nozzle 2. In this way, the circulation generating operation for generating a circulating flow in the flow passage is performed multiple times. The timing of the drive signal for driving the electrothermal transducer 5 is shown in FIGS. 7A to 7D. A discharge pulse for ejecting liquid from the ejection nozzle 2 is sent, and the first timing at which the energy generating element 35 is driven is referred to as 31a, and the second timing at which the energy generating element 35 is driven after the first timing 31a is referred to as 31b. When the discharge pulse pause period between the first timing 31a and the second timing 31b is defined as 32, the CPU 800 sends multiple element drive pulses 33 at a first time interval 33a, and then at a constant interval 34a (drive pulse pause period) which is a second time interval, to repeatedly drive the electrothermal transducer 5, thereby performing the circulation generating operation to generate a circulating flow in the flow passage.

At this time, before driving the electrothermal transducer 5, a certain time interval (34a in FIG. 7A) is set after sending the discharge pulse at the first timing 31a, and at least until the second timing 31b, the driving of the energy generating element 35 is paused. The optimal length of the drive pulse pause period 34a and the timing at which the element drive pulse 33 is sent depend on the flow resistance in the circulating flow passage, the viscosity of the liquid, and the size of the electrothermal transducer, and are determined experimentally. FIG. 7A shows the case where, within the discharge pulse pause period 32, the element drive pulse 33 is sent at each experimentally determined optimal drive pulse pause period 34a, and the electrothermal transducer 5 is driven repeatedly and evenly.

On the other hand, the discharge pulse pause period 32 between the first timing 31a and the second timing 31b for driving the energy generating element 35 varies depending on factors such as the image to be recorded on the recording medium P, the type of liquid, and the viscosity of the liquid. Therefore, depending on the timing at which the energy generating element 35 is driven, it may not be possible to set the drive pulse pause period 34a within the discharge pulse pause period 32 and send the element drive pulses 33 to drive the electrothermal transducer 5 at uniform intervals. In such cases, as shown in FIG. 7B, within the discharge pulse pause period 32, after the first timing 31a, the next element drive pulse 33 is sent and the timing at which the electrothermal transducer 5 is driven is set as the third timing. The time interval between the first timing 31a and the third timing is set as a third time interval 34b, which is different from 34a. Subsequent timings for sending the element drive pulse 33 are set at uniform intervals corresponding to the drive pulse pause period 34a, and the electrothermal transducer 5 may be driven repeatedly multiple times. Additionally, as shown in FIG. 7C, the time interval until the element drive pulse 33 is sent immediately before the second timing 31b may be set as 34c, which is different from 34a. Furthermore, as shown in FIG. 7D, the pause period from the first timing 31a, when the energy generating element 35 is driven, to the third timing when the electrothermal transducer 5 is driven, may be set as a third time interval 34b that is shorter than 34a. The timing at which the electrothermal transducer 5 is driven immediately before the second timing 31b for driving the energy generating element 35 is defined as the fourth timing, by sending the element drive pulse 33 just before the second timing 31b. The pause period between this fourth timing and the second timing 31b is set as a fourth time interval 34c, which is different from the drive pulse pause period 34a. The remaining pause periods may be set so that the element drive pulse 33 is sent at each optimal drive pulse pause period 34a, and the electrothermal transducer 5 is driven multiple times. Note that the third time interval 34b and the fourth time interval 34c are both set to be shorter than the drive pulse pause period 34a, but this is not limiting, as long as the time intervals suppress ink concentration in the flow passage and enable the generation of a circulating flow close to a steady state.

In FIGS. 7A to 7D, the drive cycle for the electrothermal transducer 5 is set to three times; however, the drive cycle of the electrothermal transducer is not particularly limited as long as it can discharge the concentrated ink in the ejection nozzle 2.

### Effect

The circulating flow in the flow passage attenuates over time and stops after a certain period. Therefore, to generate a steady circulating flow, it is necessary to repeatedly drive the electrothermal transducer. However, there is a concern that local heating due to continuous bubbling of the electrothermal transducer may cause bubble generation failure and reduce the flow rate. Therefore, it is ideal to intermittently drive the electrothermal transducer while achieving operation close to a steady flow.

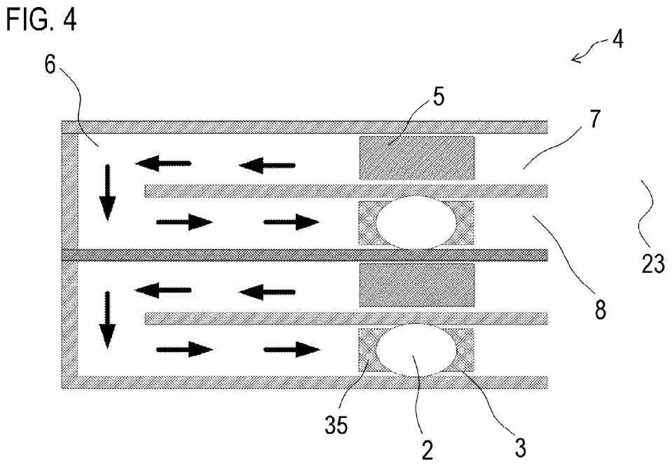

Here, as a comparative example, a U-shaped circulating flow passage configuration is shown in FIG. 4. In the U-shaped circulating flow passage configuration as shown in FIG. 4, the liquid inflow portion and discharge portion of the circulating flow passage are arranged in close proximity. Therefore, when the electrothermal transducer is intermittently driven to achieve operation close to steady flow, concentrated ink from the discharge portion side is recirculated into the inflow portion, promoting concentration and potentially causing ejection failures.

In this embodiment, as described above, a straight-type flow passage configuration is adopted in which the supply flow passage 7 and the discharge flow passage 8 are respectively arranged on one side and the other side of the pressure chamber 3 in the X direction, resulting in a configuration where the supply flow passage and the discharge flow passage of the circulating flow passage are separated. Therefore, it is possible to prevent the ink discharged from the discharge flow passage 8 from flowing back into the supply flow passage 7. As a result, it becomes possible to avoid concentration of the circulating flow. Additionally, the electrothermal transducer 5 for circulating flow inside the circulating flow passage is configured to be intermittently driven during the pulse pause period between the timings 31a and 31b at which the energy generating element 35 is driven. This enables pump driving that is close to a steady flow. In other words, by employing a flow passage configuration and driving method that suppress recirculation concentration, fresh ink can be supplied continuously to the nozzle portion where the ejection nozzle 2 is provided, thereby suppressing ink thickening at the nozzle portion.

In the above description, an electrothermal transducer was used as the first energy generating element. By driving the first energy generating element to generate heat and cause the ink inside the pressure chamber 3 to generate bubbles, ink can be ejected from the ejection nozzle 2 using the bubbling energy. The first energy generating element is not limited to electrothermal transducer, and a piezoelectric element or the like can be used.

Although an example in which an electrothermal transducer 5 is used as the second energy generating element has been illustrated in the description presented above, a piezoelectric element may be used as the second energy generating element. In the case of the piezoelectric element, the direction of the circulating flow may be opposite to that described above depending on the drive method thereof.

### Second Embodiment

Only the points of difference in the circulation configuration of the second embodiment compared to the first embodiment will be described.

### Description of Drive Signal

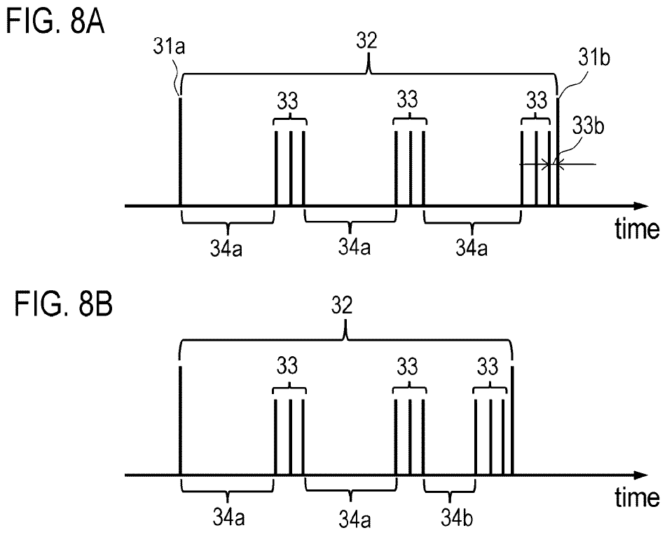

To suppress attenuation of the circulating flow in the circulating flow passage while enabling ink ejection from the ejection nozzle 2, in this embodiment, a feature is that the element drive pulse 33 is sent to drive the electrothermal transducer 5 immediately before the timing at which the energy generating element 35 is driven. The timing of the drive signals for the electrothermal transducer 5 and the energy generating element 35 in this embodiment is shown in FIGS. 8A and 8B. A discharge pulse for ejecting liquid from the ejection nozzle 2 is sent, and the first timing at which the energy generating element 35 is driven is referred to as 31a, and the second timing at which the energy generating element 35 is driven after the first timing 31a is referred to as 31b. The discharge pulse pause period between the first timing 31a and the second timing 31b is defined as 32. During this discharge pulse pause period 32, the element drive pulse 33 for driving the electrothermal transducer 5 is sent at constant intervals (drive pulse pause period 34a), thereby intermittently driving the electrothermal transducer 5 multiple times.

At this time, within the discharge pulse pause period 32, the element drive pulse 33 for driving the electrothermal transducer 5 is controlled to be sent immediately before the second timing 31b. More specifically, the element drive pulse 33 is sent immediately before the second timing 31b to drive the electrothermal transducer 5 at a fourth timing, and the fourth time interval between this fourth timing and the second timing 31b for driving the energy generating element 35 is set to be a time interval 33b that is equal to or less than the first time interval 33a. As in the first embodiment, the optimal length of the drive pulse pause period 34a and the timing at which the element drive pulse 33 is sent are determined experimentally, depending on the flow resistance in the circulating flow passage, the viscosity of the liquid, and the size of the electrothermal transducer. FIG. 8A shows the case where, within the discharge pulse pause period 32, the element drive pulse 33 is sent at each experimentally determined optimal drive pulse pause period 34a, and the electrothermal transducer 5 is driven evenly, while the fourth time interval up to the second timing 31b for driving the energy generating element 35 is set to the time interval 33b, which is equal to or less than the first time interval 33a.

On the other hand, when it is not possible to drive the electrothermal transducer 5 at even timings within the discharge pulse pause period 32, as shown in FIG. 8B, for the first several times from the first timing 31a, the element drive pulse 33 is sent within the discharge pulse pause period 32 at each even drive pulse pause period 34a to drive the electrothermal transducer 5. Then, the electrothermal transducer 5 may be driven such that the time interval between the timing at which the element drive pulse 33 is sent immediately before the second timing 31b and the timing at which the previous element drive pulse 33 is sent becomes a time interval 34b, which is shorter than the time interval 34a.

### Effect

If, as in the first embodiment, there is a pause period during the discharge pulse pause period 32 just before the timing at which the energy generating element 35 is driven in which the electrothermal transducer 5 is not driven, there is concern that the circulation efficiency of the ink just before the discharge pulse may decrease. Therefore, as in the present embodiment, by driving the electrothermal transducer 5 immediately before sending the discharge pulse and driving the energy generating element 35, it becomes possible to perform ejection while maintain the circulation effect at the nozzle portion.

In this case, further improvement in circulation efficiency can be achieved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-156981, filed on Sep. 10, 2024, which is hereby incorporated by reference herein in its entirety.

What is claimed is:

1. A liquid ejection head comprising:
a plurality of liquid ejection portions each having an ejection nozzle for ejecting liquid, a pressure chamber, and a first energy generating element for generating energy to eject the liquid from the ejection nozzle;
a plurality of circulating flow passages provided corresponding to the plurality of liquid ejection portions, each circulating flow passage having a supply port through which liquid supplied to the pressure chamber flows in and a discharge port through which liquid collected from the pressure chamber is discharged, the pressure chamber being disposed between the supply port and the discharge port; and
a second energy generating element provided in the circulating flow passage;
wherein the plurality of liquid ejection portions are arranged in a first direction,
wherein each of the plurality of circulating flow passages extends in a second direction intersecting the first direction, such that the supply port is located on one side of the pressure chamber in the second direction, the discharge port is located on the other side of the pressure chamber in the second direction, and the supply port, pressure chamber, and discharge port are arranged in this order in the second direction,
wherein the second energy generating element is disposed in the circulating flow passage on a side closer to the supply port than the pressure chamber,
wherein the second energy generating element is driven multiple times at a first time interval between a first timing at which the first energy generating element is driven and a second timing at which the first energy generating element is driven next after the first timing, and
wherein a third time interval between the first timing and a third timing at which the second energy generating element is driven next after the first timing includes a circulation generating operation greater than the first time interval.

2. The liquid ejection head according to claim 1, further comprising:
a substrate on a first surface side on which the liquid ejection portion, the circulating flow passage, and the second energy generating element are disposed,
wherein the substrate comprises:
a supply-side through flow passage penetrating the substrate in a third direction intersecting both the first and second directions, between the first surface of the substrate and a second surface which is a back surface of the first surface, on an outer side of the supply port; and
a discharge-side through flow passage penetrating the substrate in the third direction, between the first surface and the second surface, on an outer side of the discharge port, and
wherein a common flow passage communicating with the supply-side through flow passage and the discharge-side through flow passage is formed on the second surface side.

3. The liquid ejection head according to claim 2, further comprising:
a flow passage forming member laminated on the first surface of the substrate, the flow passage forming member including a plurality of partition walls extending in the second direction between the plurality of first energy generating elements aligned in the first direction in the plurality of liquid ejection portions; and
an orifice plate provided with the ejection nozzle and laminated on an opposite side of the substrate with respect to the flow passage forming member, and
wherein the pressure chamber and the circulating flow passage are defined by the first surface of the substrate, the partition wall, and the orifice plate.

4. The liquid ejection head according to claim 3,
wherein the flow passage forming member is a first flow passage forming member, the liquid ejection head further comprising
a second flow passage forming member laminated on the second surface of the substrate, the second flow passage forming member defining the common flow passage together with the second surface, and
wherein the common flow passage communicates with each of the plurality of circulating flow passages via the supply-side through flow passage and the discharge-side through flow passage.

5. The liquid ejection head according to claim 3,
wherein the flow passage forming member is a first flow passage forming member, the liquid ejection head further comprising
a second flow passage forming member laminated on the second surface of the substrate, defining the common flow passage together with the second surface, and
wherein the common flow passage comprises:
a supply-side common flow passage communicating with each of the plurality of circulating flow passages via the supply-side through flow passage; and
a discharge-side common flow passage communicating with each of the plurality of circulating flow passages via the discharge-side through flow passage.

6. The liquid ejection head according to claim 1,
wherein the second energy generating element is an electrothermal transducer.

7. A liquid ejection apparatus comprising:
the liquid ejection head according to claim 1; and
a control portion for controlling driving of the second energy generating element,
wherein the control portion drives the second energy generating element while driving of the first energy generating element is stopped.

8. The liquid ejection apparatus according to claim 7,
wherein the control portion controls the circulation generating operation so as to be repeated multiple times at a second time interval longer than the first time interval while driving of the first energy generating element is stopped.

9. The liquid ejection apparatus according to claim 8,
wherein the third time interval between the first timing and the third timing is different from the second time interval.

10. The liquid ejection apparatus according to claim 8,
wherein, in the circulation generating operation, in a case where the second energy generating element is driven at a fourth timing immediately before the second timing, a fourth time interval between the fourth timing and the second timing is different from the second time interval.

11. The liquid ejection apparatus according to claim 10,
wherein the fourth time interval is equal to or less than the first time interval.

12. A method for driving a liquid ejection head,
the liquid ejection head comprising:
a plurality of liquid ejection portions aligned in a first direction, each liquid ejection portion having an ejection nozzle for ejecting liquid, a pressure chamber, and a first energy generating element for generating energy to eject the liquid from the ejection nozzle;
a plurality of circulating flow passages provided corresponding to the plurality of liquid ejection portions, each circulating flow passage having a supply port through which liquid supplied to the pressure chamber flows in and a discharge port through which liquid collected from the pressure chamber is discharged, the pressure chamber being disposed between the supply port and the discharge port; and
a second energy generating element disposed in the circulating flow passage on a side closer to the supply port than the pressure chamber;
the method including:
driving the first energy generating element to eject liquid from the ejection nozzle;
performing a circulation generating operation in which the second energy generating element is driven to generate a flow of liquid in the circulating flow passage in the order of the supply port located on one side of the pressure chamber in a second direction intersecting the first direction, the pressure chamber, and the discharge port located on the other side of the pressure chamber in the second direction,
wherein, in the circulation generating operation, the second energy generating element is driven multiple times at a first time interval between a first timing at which the first energy generating element is driven and a second timing at which the first energy generating element is driven next after the first timing, and
a third time interval between the first timing and a third timing at which the second energy generating element is driven next after the first timing is greater than the first time interval.

13. The method for driving a liquid ejection head according to claim 12,
wherein the second energy generating element is intermittently driven to generate an intermittent flow in the circulating flow passage.
